(19) United States
(12) Patent Application Publication
(10) Pub. No.: US 2026/0319212 A1
(43) Pub. Date: Oct. 15, 2026

(54) ASSEMBLY OF HOLLOW CORE OPTICAL FIBERS

(71) Applicant: CORNING INCORPORATED, CORNING, NY (US)

(72) Inventors: Anatoli Anatolyevich Abramov, Painted Post, NY (US); Antoine Gaston Denis Bisson, Painted Post, NY (US); Christopher Charles Chilson, Wellsboro, PA (US); Kenneth Charles Driesbaugh, Elmira, NY (US); Philip Robert LeBlanc, Corning, NY (US); Xiang-Dong Mi, Corning, NY (US)

(21) Appl. No.: 19/636,332

(22) Filed: Apr. 1, 2026

Related U.S. Application Data
(60) Provisional application No. 63/788,211, filed on Apr. 14, 2025.

(51) Int. Cl. G02B 6/44

(52) U.S. Cl. CPC G02B 6/4489

(57) ABSTRACT

Disclosed are various examples for systems and methods for holding primary tubes and nested tubes against the interior wall of an outer tube to form a hollow core optical fiber preform. Various jigs or an expansion insert may be employed to apply force against the primary tubes, thereby holding the primary tubes against the interior wall of the outer tube. In addition, a jig may be employed to position the nested tubes within the primary tubes.

This Application claims the benefit of priority to U.S. Provisional Patent Application Ser. No. 63/788,211 filed on Apr. 14, 2025, the content of which is relied upon and incorporated herein by reference in its entirety.

### BACKGROUND

Traditional optical fibers have a solid glass or plastic core. Solid core optical fibers have been used for decades by the telecommunication industry for data transmission. However, hollow core optical fibers have been recognized as having many advantages over solid core optical fibers, such as lower signal losses, lower dispersion, less susceptibility to optical damage, and other advantages. Typically, hollow core optical fibers channel light through a hollow core that is filled with air or vacuum.

The optical properties of hollow-core optical fibers can be defined by a confinement of light by the anti-resonant cladding elements at the core-cladding interface. Low-loss transmission of light in the core is achieved through coherence effects from the thin core walls, which may be modeled as Fabry-Perot resonators. If anti-resonance conditions are met, then the confinement by a capillary wall increases and optical losses from the core into the cladding are reduced.

### SUMMARY

In one example, an apparatus for assembly of an optical fiber preform is set forth comprising a center insert having at least one primary tube positioning guide, the at least one primary tube positioning guide being configured to position a corresponding at least one primary tube against an interior wall of an outer tube. The apparatus further includes a projection that extends outward from the center insert, the projection including at least one nested tube guide, where the at least one nested tube guide is configured to hold a corresponding at least one nested tube against an inner wall of the at least one primary tube. Also, the projection holds the at least one nested tube simultaneously with the positioning of the at least one primary tube against the interior wall of the outer tube.

In another example, an arrangement is provided for assembly of an optical fiber preform. The arrangement comprises an outer tube and a plurality of primary tubes within the outer tube. The arrangement further comprises a plurality of nested tubes, where individual ones of the nested tubes are positioned within corresponding ones of the primary tubes. A jig simultaneously positions individual ones of the primary tubes against an interior wall of the outer tube and individual ones of the nested tubes inside a corresponding one of the primary tubes.

In addition, an example of a method is provided that comprises positioning at least one primary tube within an outer tube, positioning at least one nested tube within the corresponding at least one primary tube, and employing a jig to simultaneously position the at least one primary tube against an interior wall of the outer tube, and the at least one nested tube against an inner wall of the at least one primary tube.

In a further example, an apparatus for assembly of an optical fiber preform, comprising a center body, a plurality of tube positioning guides, and a plurality of living hinges, each of the living hinges connecting a respective one of the tube positioning guides to the center body. A first set of the living hinges extend longitudinally from the center body in a first direction, and a second set of the living hinges extend longitudinally from the center body in a second direction, the second direction being opposite of the first direction.

In another example, an method is provided for assembly of an optical fiber preform, the method comprising inserting a plurality of primary tubes within an outer tube; inserting a jig having a center body and a plurality of tube positioning guides into the outer tube, each of the tube positioning guides being connected to the center body by way of a living hinge; and positioning each of the primary tubes against an interior wall of the outer tube by way of the tube positioning guides, where a first set of the living hinges extends longitudinally from the center body in a first direction, and a second set of the living hinges extends longitudinally from the center body in a second direction, the second direction being opposite of the first direction.

In an additional example, an apparatus for assembly of an optical fiber preform is provided that comprises a ring structure and a plurality of external grips extending from the ring structure in a longitudinal direction associated with the ring structure. A plurality of arms extend radially inward from the ring structure, and a plurality of pins are provided, each pin extending in the longitudinal direction from a respective one of the arms.

In a further example, a method for assembly of an optical fiber preform is provided that comprises disposing a jig onto an end of an outer tube, the jig having a ring structure with a plurality of external grips extending from the ring structure in a longitudinal direction associated with the ring structure; inserting a plurality of pins into a corresponding plurality of nested tubes, each of the nested tubes being positioned in one of a plurality of primary tubes, the primary tubes being positioned inside the outer tube; and positioning both the primary tubes within the outer tube, and each of the nested tubes inside a corresponding one of the primary tubes by virtue of pivoting a plurality of arms extending radially inward from the ring structure, wherein each of the pins extends in the longitudinal direction from a distal end of a respective one of the arms.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a hollow core optical fiber preform constructed in accordance with the various examples of the present disclosure.

FIG. 2 is a drawing of an example of a center insert of a jig employed in the construction of a hollow core optical fiber preform in accordance with an example of the present disclosure.

FIG. 3 is a drawing of the center insert of FIG. 2 as it is employed to position primary tubes in the construction of a hollow core optical fiber preform in accordance with an example of the present disclosure.

FIG. 4 is a drawing of an example of a jig employed to position primary tubes and nested tubes in the construction of a hollow core optical fiber preform in accordance with an example of the present disclosure.

FIG. 5 is a drawing of the jig of FIG. 4 as it is employed in the construction of a hollow core optical fiber preform in accordance with an example of the present disclosure.

FIG. 6 is a further view of the jig of FIG. 4 as it is employed in the construction of a hollow core optical fiber preform in accordance with an example of the present disclosure.

FIGS. 7A, 7B, and 7C depict end views of examples of jigs employed in the construction of a hollow core optical fiber preform in accordance with further examples of the present disclosure.

FIG. 8 is a flowchart of a method for employing the jig of FIG. 4 to construct a hollow core optical fiber preform in accordance with an example of the present disclosure.

FIG. 9A is a drawing of another example of a jig that is employed to position primary tubes in the construction of a hollow core optical fiber preform in accordance with an example of the present disclosure.

FIG. 9B is a drawing that depicts the use of the jig of FIG. 9A as it is employed in the construction of a hollow core optical fiber preform in accordance with an example of the present disclosure.

FIG. 9C is a flowchart of a method for employing the jig of FIG. 9A to construct a hollow core optical fiber preform in accordance with an example of the present disclosure.

FIG. 10A is a drawing of another example of a jig that is employed to position primary tubes and nested tubes in the construction of a hollow core optical fiber preform in accordance with an example of the present disclosure.

FIG. 10B is a drawing that depicts the use of the jig of FIG. 10A as it is employed in the construction of a hollow core optical fiber preform in accordance with an example of the present disclosure.

FIG. 10C is a flowchart of a method for employing the jig of FIG. 10A to construct a hollow core optical fiber preform in accordance with an example of the present disclosure.

FIG. 11 is a block diagram of another example of an approach for positioning primary tubes in the construction of a hollow core optical fiber preform in accordance with an example of the present disclosure.

FIGS. 12A and 12B are drawings of another example of a jig for positioning primary tubes in the construction of a hollow core optical fiber preform in accordance with an example of the present disclosure.

### DETAILED DESCRIPTION

Disclosed are various approaches that employ jigs to construct hollow core optical fiber preforms in accordance with various examples of the present disclosure. As set forth herein, various jigs are employed to hold primary tubes and nested tubes inside an outer tube or cladding tube so that the primary tubes and nested tubes can be welded in place using one of a number of different types of welding techniques. In doing so, a hollow core optical fiber preform may be constructed from which hollow core optical fibers may be drawn.

Although the following discussion provides illustrative examples of the operation of various jigs and other components of the present disclosure, the use of the following illustrative examples does not exclude other implementations that are consistent with the principals disclosed by the following illustrative examples.

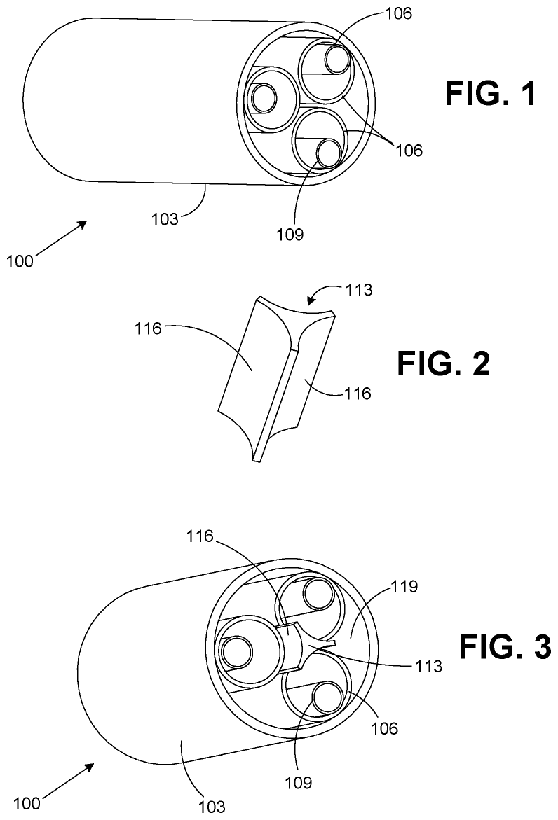

With reference to FIG. 1, shown is drawing of an example of a hollow core optical fiber preform 100. The hollow core optical fiber preform 100 includes an outer tube 103 with a plurality of primary tubes 106. Nested within each of the primary tubes 106 is a corresponding nested tubes 109. It is understood that although the hollow core optical fiber preform 100 is shown as having three primary tubes 106 with corresponding nested tubes 109, the hollow core optical fiber preform 100 may have any number of primary tubes 106 with corresponding nested tubes 109.

With reference then to FIG. 2, shown is an example of a center insert 113 that is configured to position multiple primary tubes 106 against an interior wall of the outer tube 103. The center insert 113 includes a plurality of primary tube positioning guides 116. Each primary tube positioning guide 116 engages a respective one of the primary tubes 106 as will be described.

Referring next to FIG. 3, shown is an example of the hollow core optical fiber preform 100 with a center insert 113 inserted in between the primary tubes 106. In the example shown, each primary tube positioning guide 116 is compatible with or conforms to a side of one of the primary tubes 106. For example, a face of each of the primary tube positioning guides 116 may be concave having a curvature or radius that matches an outer diameter of the primary tubes 106. Alternatively, the face of each primary tube positioning guide 116 may be V-shaped such that the sides of a respective primary tube positioning guide 116 touches the primary tube 106 at respective contact points or along a length of the center insert 113. In this respect, the V-shaped primary tube positioning guides 116 include a pair of flat faces, where the individual ones of the flat faces are configured to contact a respective primary tube 106. Thus, a given primary tube 106 is held in place by a respective set of two flat faces of one of the primary tube positioning guides 116. In addition, each primary tube positioning guide 116 may be shaped in some other manner.

The primary tube positioning guides 116 may be angularly spaced at even intervals on the center insert 113. Alternatively, the primary tube positioning guides 116 may be angularly spaced in some other manner such as at random or some other angular spacing as can be appreciated.

As depicted in FIG. 3, the center insert 113 is positioned in a center of the hollow core optical fiber preform 100 such that each primary tube positioning guide 116 engages with a corresponding one of the primary tubes 106. In this respect, the center insert 113 positions each of the primary tubes 106 against an interior wall 119 of the outer tube 103. In one example, the center insert 113 fits snugly between the primary tubes 106 such that the primary tubes 106 are both held against the interior wall 119 and are held in positions relative to each other so that the primary tubes 106 are angularly spaced inside the interior wall 119 of the outer tube 103 at even angular intervals.

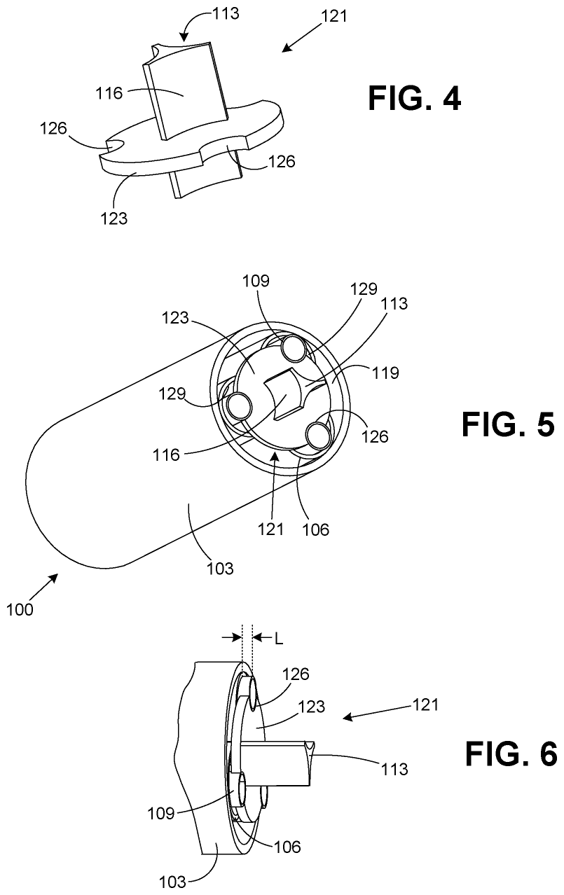

Referring next to FIG. 4, shown is a view of a jig 121 that includes the center insert 113 and an annular projection 123 according to an example of the present disclosure. In one example, the annular projection 123 is in the form of a disk-shaped structure although the annular projection 123 may be in some other form. The annular projection 123 extends outward from the center insert 113. The annular projection 123 includes a plurality of nested tube guides 126. The individual ones of the nested tube guides 126 are configured to hold a respective one of the nested tubes 109 against an inner wall of a respective one of the primary tubes 106 as will be described.

Although the annular projection 123 comprises a disk-like structure, it may be constructed in some other manner. For example, rather than a single annular projection 123, multiple projections may extend from the center insert 113, where each of the nested tube guides 126 is disposed on the end of each projection.

In one example, each of the nested tube guides 126 comprises a cutout that seats a respective one of the nested tubes 109. Each of the cutouts may be concave such that a contour of the cutout matches an outer diameter of the nested tubes 109. Alternatively, the cutouts may be V-shaped or other shape as is appropriate to hold the nested tubes 109 in position.

Referring next to FIG. 5, shown is a view of an example of the jig 121 comprising the center insert 113 with the annular projection 123 as it is positioned at the end of a hollow core optical fiber preform 100. A portion of the center insert 113 is inserted between the primary tubes 106, where the primary tube positioning guides 116 hold the primary tubes 106 at predefined positions against the interior wall 119 of the outer tube 103. As mentioned above, the primary tube positioning guides 116 may hold the primary tubes 106 at even intervals around the interior wall 119 of the outer tube 103. At the same time, the nested tube guides 126 hold the nested tubes 109 against the inner walls 129 of corresponding ones of the primary tubes 106.

In addition, although the annular projection 123 is shown as partially covering the opening of the outer tube 103, it is understood that the annular projection 123 may extend to the edges of the outer tube 103 to minimize contaminants from entering the outer tube 103 and the primary tubes 106, where minimal openings are provided to accommodate laser welding of the primary tubes 106 to the outer tube 103 or the nested tubes 109 to the primary tubes 106. In addition, openings may be provided to allow air to escape the outer tube 103, primary tubes 106, or nested tubes 109 where purging air is injected into the hollow core optical fiber preform 100 to keep contaminants from settling on the inside of the outer tube 103 or on the primary tubes 106 or the nested tubes 109. Such contaminants may be generated by laser welding or other processes as can be appreciated.

Referring next to FIG. 6, shown is a side view of a portion of the hollow core optical fiber preform 100 having the jig 121 inserted therein. As shown, the nested tubes 109 extend longitudinally beyond the primary tubes 106 by extended length L so that the nested tube guides 126 of the jig 121 are able to engage with the nested tubes 109. Alternatively, in a situation where the nested tubes 109 do not extend beyond the primary tubes 106, or stated another way, where the ends of the nested tubes 109 are flush with the ends of the primary tubes 106, a portion of the annular projection 123 may extend into the primary tubes 106 to engage with and hold the nested tubes 109 in a desired position.

With reference back to FIG. 5, the jig 121 that includes the center insert 113 and the annular projection 123 facilitates the construction of the hollow core optical fiber preform 100. For example, by first placing the primary tubes 106 within the outer tube 103, and the nested tubes 109 into the primary tubes 106 using a fixture on a first end of the outer tube 103, the jig 121 is then put into place to hold primary tubes 106 in predefined positions against the interior wall 119 of the outer tube 103 and, at the same time, the nested tubes 109 are held in place against the inner walls 129 of respective ones of the primary tubes 106. In this respect, the nested tube guides 126 of the annular projection 123 hold the nested tubes 109 against the inner walls 129 of the respective primary tubes 106 while, simultaneously, positioning the primary tubes 106 against the interior wall 119 of the outer tube 103. This is done so that the primary tubes 106 may be attached to the interior wall 119 of the outer tube 103 and the nested tubes 109 may be attached to the inner walls 129 of the primary tubes 106, respectively, by way of laser welding, flame welding, hydrogen welding, propane welding, arc welding, plasma welding, or other appropriate type of welding.

In addition, although the jig 121 is applied to one side of the hollow core optical fiber preform 100 as shown, it is understood that two jigs 121 may be employed, where such jigs 121 are applied to both ends of the hollow core optical fiber preform 100. An appropriate structure may be employed to ensure that the respective jigs 121 on either side of the hollow core optical fiber preform 100 are properly aligned relative to each other.

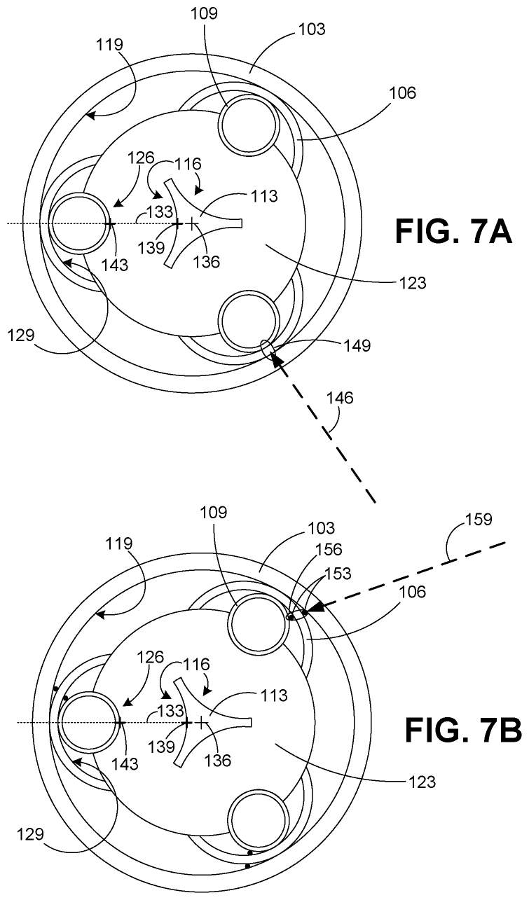

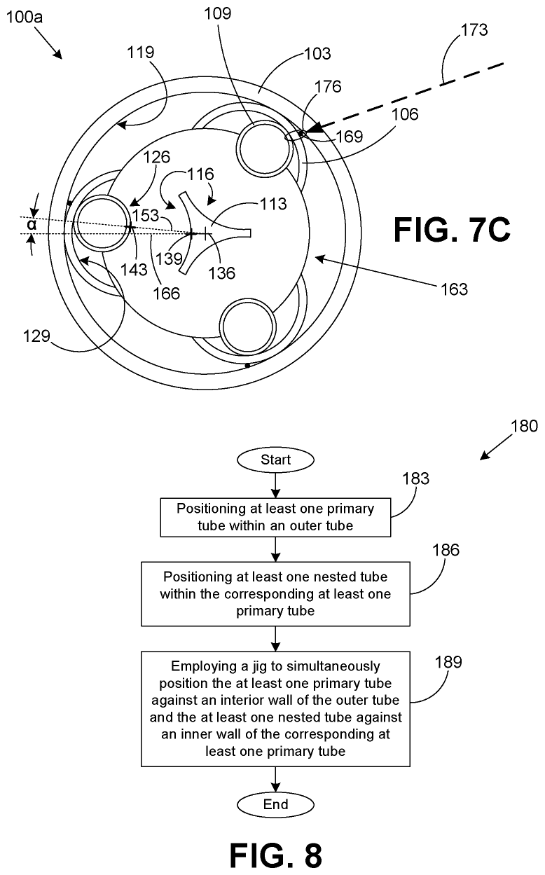

Referring next to FIG. 7A, shown is a view of the end of the hollow core optical fiber preform 100 with the jig 121 inserted therein. As shown, the primary tube positioning guides 116 and the nested tube guides 126 are radially aligned relative to radial axis 133 extending from a preform center 136 of the hollow core optical fiber preform 100. In this respect, a primary center 139 of each of the primary tube positioning guides 116 is aligned with a nested center 143 of a corresponding one of the nested tube guides 126, where both the primary center 139 and the nested center 143 fall on the same radial axis 133.

By virtue of the relative positions of the primary tubes 106 and the nested tubes 109 such that the primary tubes 106 and the nested tubes 109 are in radial alignment, a laser 146 may be directed to a laser welding zone 149. This laser welds the primary tube 106 to the outer tube 103, and the nested tube 109 to the primary tube 106. Given the proximity of the edges of the outer tube 103 relative to the primary tube 106, and nested tube 109, it is possible to perform a single welding operation to weld each instance of the three tubes together.

Referring next to FIG. 7B, shown is a view of the end of an alternative hollow core optical fiber preform 100 with the jig 121 inserted therein. As shown, welding material 153 may be positioned at a predefined location and welding of the nested tube 109 to the primary tube 106, and the primary tube 106 to the outer tube 103 is performed with a single welding operation focused on the entire welding zone 156 or by way of two or more welding operations focused on smaller zones centered on the welding material 153. In this respect, a welding laser 159 may be directed to the entire welding zone 156 or to smaller welding zones centered around the welding material 153. Also, two welding materials 153 may not be aligned along a single line when they have the same or similar sizes. Alternatively, some other welding approach may be employed such as flame welding, hydrogen welding, propane welding, arc welding, plasma welding, or other appropriate type of welding. Embodiments of welding material 153 include bonding compounds based on silica, such as aqueous-based or solvent-based slurries or grits containing silica particles having particle diameters on the order of a few to tens of microns.

Referring next to FIG. 7C, shown is a view of the end of an alternative hollow core optical fiber preform 100, denoted as hollow core optical fiber preform 100a, with an angularly offset jig 163 inserted therein. While most components of the hollow core optical fiber preform 100a are similar to the hollow core optical fiber preform 100 (FIGS. 7A and 7B), the hollow core optical fiber preform 100a differs in that the primary center 139 of the primary tube positioning guide 116 is angularly offset by angle α relative to the nested center 143 of the nested tube guide 126.

To this end, as shown in FIG. 7C, a first axis 133 extends from a preform center 136 of the jig 163 through the primary center 139 of the primary tube positioning guide 116. Also, a second axis 166 extends from the center of the jig 163 through the nested center 143 of the nested tube guide 126. Given the angle α between the first axis 133 and the second axis 166, the primary center 139 is angularly offset from the nested center 143. As such, the primary tube positioning guides 116 are radially misaligned with respect to the nested tube guides 126. The angle α may be, for example any angle from 1 degrees to 90 degrees. It should be noted that the angle α may vary from one paired primary tube positioning guide 116 and nested tube guide 126 to the next. Also, the angle α in one instance may be a first value and in a second instance may be a second value. In one example, the angle α for one instance may be the opposite or negative the value of a second instance.

By virtue of the fact that the primary tube positioning guides 116 are radially misaligned with respect to the nested tube guides 126, the nested tubes 109 are placed in a position that facilitates welding. For example, welding material 169 may be positioned between the primary tube 106 and the outer tube 103 as shown. A laser 173 may be directed to a welding zone 176 that includes the welding material 169. The laser 173 is of a power and wavelength such that the nested tube 109 is welded to the primary tube 106, and the primary tube 106 is welded to the outer tube 103 in a single welding operation. The welding material 169 facilitates the welding of the primary tube 106 to the outer tube 103.

With reference back to FIG. 5, although the hollow core optical fiber preform 100 as depicted (and as depicted in other figures) shows that there are 3 primary tubes 106 positioned within the outer tube 103, it is understood that the number of primary tubes 106 shown is merely illustrative, and that the number of primary tubes 106 and corresponding nested tubes 109 can vary from the numbers shown. For example, the number of primary tubes 106 and corresponding nested tubes 109 may be 3, 4, 5, 6, 7, 8, 9, or other number. Alternatively, the number of primary tubes 106 and corresponding nested tubes 109 within the outer tube 103 may fall within a range of 3 to 9, a range of 4 to 8, a range of 5 to 7, or other range.

Correspondingly, for a given jig 121, the number of primary tubes positioning guides 116 and corresponding nested tube guides 126 may vary. For example, the number of primary tube positioning guides 116 included in the center insert 113 may be 3, 4, 5, 6, 7, 8, 9, or some other number. Alternatively, the number of primary tube positioning guides 116 included in the center insert 113 may fall into a range of 3 to 9, 4 to 8, 5 to 7, or other range.

In addition, where a single laser 146 (FIGS. 7A), 159 (FIG. 7B), and 173 (FIG. 7C) are shown, it is understood that the hollow core optical fiber preform 100 may be rotated to allow the laser to weld all of the nested tubes 109 to the primary tubes 106, and all of the primary tubes 106 to the outer tube 103. Alternatively, for shorter assembly time, multiple lasers may be employed, where each laser is directed to perform multiple welds simultaneously or with partial concurrence. Given that the jig 121 simultaneously holds the nested tubes 109 and the primary tubes 106 within the outer tube 103, the outer tube 103 may be situated in any orientation including horizontally, vertically, or at a slanted angle.

Further, it is possible that a nested tube 109 may not be included in one or more of the primary tubes 106. In such case, it would not be necessary to include a corresponding nested tube guide 126 where no nested tube 109 is to be welded in place.

Also, it is possible that multiple ones of the hollow core optical fiber preform 100 may be employed within a single larger cladding to produce a further preform.

Referring next to FIG. 8, shown is an example of a method 180 for constructing a hollow core optical fiber preform 100 (FIG. 1). In box 183, the method begins by positioning a plurality of primary tubes 106 (FIG. 5) within an outer tube 103 (FIG. 5). Thereafter in box 186, the method includes positioning individual ones of the nested tubes 109 (FIG. 5) within corresponding ones of the primary tubes 106. Then in box 189, the method further comprises employing a jig to simultaneously position individual ones of the primary tubes 106 against an interior wall of the outer tube 103 and individual ones of the nested tubes 109 against an inner wall 129 of a corresponding one of the primary tubes 106.

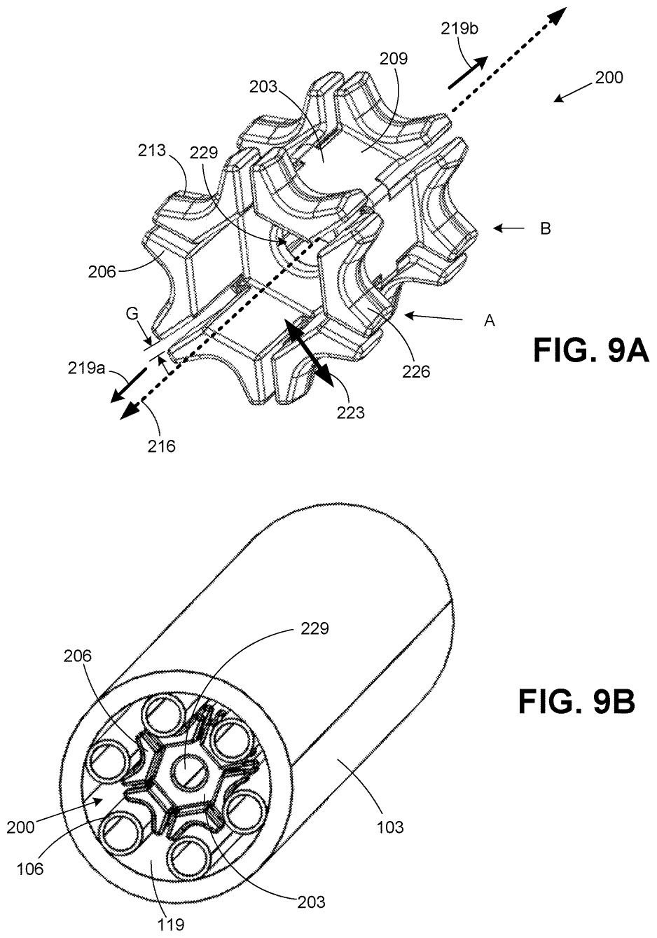

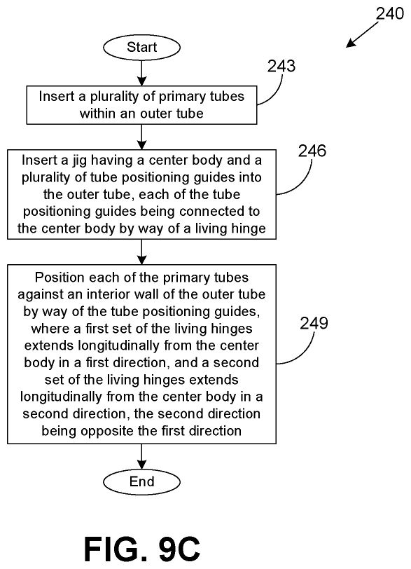

With reference to FIG. 9A, shown is an example of a jig 200 that is employed for the assembly of a hollow core optical fiber preform 100 (FIG. 1). The jig 200 includes a center body 203 and a plurality of tube positioning guides 206. Each of the tube positioning guides 206 is connected to the center body 203 by a living hinge 209.

Each of the tube positioning guides 206 are shaped to contact a side of a primary tube 106 (FIG. 3) thereby holding the primary tube 106 against an interior wall 119 (FIG. 3) of an outer tube 103 (FIG. 3). For example, the tube positioning guides 206 may comprise a V-block or a crowned V-block. Alternatively, the two tube positioning guides 206 may be circular or concave in shape such that the shape of the tube positioning guides 206 matches the shape of a side wall of the primary tubes 106.

In the event that the tube positioning guides 206 comprise crowned V-blocks, the crowned V-blocks present a ridge 213 that provides for contact points against the side of a primary tube 106. Such crowned V-blocks aid in preventing binding and ensure a positive contact with the primary tubes 106. Also, the crowned V-blocks prevent the jig 200 from twisting and ensures an even load distribution. Further, tube positioning guides 206 that embody a crowned V-block at both ends prevent the jig 200 from becoming cocked in the outer tube 103 to ensure proper alignment of the primary tubes 106.

The jig 200 is arranged around a center longitudinal axis 216. A first set of the living hinges 209 extends longitudinally from the center body 203 in a first direction 219a and a second set of the living hinges 209 extends longitudinally from the center body 203 in a second direction 219b. The second direction 219b is the opposite of the first direction 219a.

Each of the living hinges 209 flexes to move a respective one of the tube positioning guides 206 in a direction 223 perpendicular to the center longitudinal axis 216 of the jig 200. If no pressure is applied to the tube positioning guides 206, the living hinges 209 remain in a resting position. However, the tube positioning guide 206 can move away from or closer to the center longitudinal axis 216 of the jig 200 by virtue of the flexing of the living hinges 209. Each of the tube positioning guides 206 extends further radially outward relative to the center longitudinal axis 216 that does the corresponding living hinge 209 to which a respective tube positioning guide 206 is attached.

The flexibility of the living hinges 209 may be specified by varying a length of the living hinges 209. That is to say, as the length of the living hinges 209 increases, the flexibility increases and the amount of force applied onto the primary tubes 106 by the tube positioning guides 206 disposed on the free end of the living hinges 209 decreases. As the living hinges 209 decrease in length, the flexibility decreases and the force applied onto the primary tubes 106 by the tube positioning guides 206 increases.

Similarly, the thickness of the living hinges 209 may be specified to allow for sufficient flexibility across a range of sizes of primary tubes 106. If the living hinges 209 are too thin, then they might not generate enough force to hold the primary tubes 106 against the interior wall 119 of the outer tube 103. If the living hinges 209 are too thick, then they may lack compliance that is potentially needed to accommodate variations in diameters of primary tubes 106, which can potentially lead to misalignment, excessive force against the primary tubes 106, or excessive force needed to insert the jig 200 into the outer tube 103.

The tube positioning guides 206 are arranged into longitudinally aligned pairs A/B. Each of the longitudinally aligned pairs A/B includes a first one of the tube positioning guides 206 that is attached to a first one of the living hinges 209 from the first set, and a second one of the tube positioning guides 206 that is attached to a second one of the living hinges 209 from the second set. The longitudinal alignment of the respective tube positioning guides 206 and 206 allows both to be seated against a single primary tube 106 as will be described.

In one example, the longitudinally aligned pairs A/B of tube positioning guides 206 are arranged in the form of a polygon. Stated another way, a cross section of the tube positioning guides 206 or of the living hinges 209 shows a polygonal arrangement. In the example depicted in FIG. 9A, the tube positioning guides 206 or living hinges 209 are arranged in the form of a hexagon. The specific polygonal shape to be employed depends upon how many primary tubes 106 are to be held in position within a given outer tube 103, where the number of sides of the polygonal shape equal the number of primary tubes 106 to be held in position within the outer tube 103.

In one example, a gap G exists between adjacent ones of the tub positioning guides 206 and the living hinges 209. The width of the gap G is specified to prevent interference between adjacent ones of the tube position guides 206 during operational flexing of corresponding one of the living hinges 209. In this respect, the width of the gap G may be specified so that a predefined magnitude of movement of a given tube positioning guide 206 in a perpendicular direction relative to the center longitudinal axis 216 is achieved by flexing of a corresponding one of the living hinges 209.

In addition, the gap G between adjacent tube positioning guides 206 may be specified to prevent an over-flexing of respective adjacent ones of the living hinges 209. In this respect, if adjacent tube positioning guides 206 are pressed radially inward such that a collision occurs between adjacent tube positioning guides 206, the resulting interference between adjacent tube positioning guides 206 prevents an over-flexing of the adjacent ones of the living hinges 209 when the jig 200 is installed into an outer tube 103 to hold the primary tubes 106 in position as will be described. This protects the jig 200 from breaking during insertion into the outer tube 103, thereby maintaining durability while allowing for controlled flexibility during repeated use.

In one example, the distal ends of the tube positioning guides 206 include a taper 226 in the longitudinal direction. Specifically, the ends of the tube positioning guides 206 facing in the first direction 219a and the second direction 219b are tapered to facilitate easier insertion of the jig 200 into an outer tube 103 with a number of primary tubes 106 disposed therein.

The jig 200 further includes an extraction structure 229 attached to or otherwise disposed in or on the center body 203. In one example, the extraction structure 229 comprises a hole in the center of the center body 203. To extract the jig 200 from inside an outer tube 103, where the jig 200 holds the primary tubes 106 therein, a hook may be inserted into the hole to grasp the jig 200 and pull it out of the outer tube 103. Alternatively, a tab or other projection may extend from the center of the body that includes a hole or other structure that also may be grasped with a hook or other implement in order to pull or extract the jig 200 from the outer tube 103. Where the extraction structure 229 is a hole, the diameter of the hole may be specified to allow purging gas to flow therethrough to aid in purging contaminants from the hollow core optical fiber preform 100 during construction.

The jig 200 may be constructed of various materials including, for example, Polytetrafluoroethylene (PTFE) or various metals. The jig 200 may be 3D printed. If the jig 200 is constructed from a metal, the resulting metal surfaces may be coated with plastic such as PTFE or other non-marring coating material to protect the primary tubes 106.

To improve the strength and rigidity of a 3D printed version of the jig 200, coatings such as Cerakote® produced by NIC Industries Incorporated of White City, Oregon can be applied due to their flexible and structural properties. Additionally, a vapor smoothing process can be used to eliminate surface irregularities inherent in layered 3D-printed structures, ensuring smoother insertion into, and removal from, the outer tube 103.

To ensure that the jig 200 does not damage the primary tubes 106 or the outer tube 103, all edges or corners of the jig 200 may be rounded, thereby ensuring smoother insertion and extraction of the jig 200 into and from the outer tube 103. Also, since the jig 200 may be positioned deeper inside the outer tube 103 and the primary tubes 106, the ends of the outer tube 103 and the primary tubes 106 are open for tooling and welding processes without obstruction.

For a given jig 200, the number of tube positioning guides 206 may vary. For example, although there are tube positioning guides 206 to position six primary tubes 106, the number of tube positioning guides 206 may be 3, 4, 5, 6, 7, 8, 9, or some other number. Alternatively, the number of tube positioning guides 206 included in the jig 200 may position a number of primary tubes 106 that falls into a range of 3 to 9, 4 to 8, 5 to 7, or other range.

Referring next to FIG. 9B, shown is an example of an outer tube 103 with six primary tubes 106 disposed therein. In addition, the jig 200 is inserted into the outer tube 103 where the primary tubes 106 are seated in the tube positioning guides 206. As the jig 200 is inserted into the outer tube 103, the taper 226 at the distal ends of the tube positioning guides 206 make it easier to insert the jig 200 without a direct collision with the primary tubes 106. As the jig 200 is inserted, the tube positioning guides 206 seat against the primary tubes 106 and the corresponding living hinges 209 (FIG. 9A) flex such that the tube positioning guides 206 moved radially inward toward the center longitudinal axis 216 (FIG. 9A). The living hinges 209 present a predefined amount of resistance to the movement, thereby applying a force against the primary tubes 106 that holds the primary tubes in place against the interior wall 119 of the outer tube 103. The jig 200 also holds the primary tubes 106 against the interior wall 119 at even intervals around the interior wall 119 of the outer tube 103.

The living hinges 209 flex radially inwardly when the tube positioning guides 206 contact the primary tubes 106 to accommodate the diameter of each of the primary tubes 106. If the tube positioning guides comprise V-blocks as described above, each side of the V-blocks contacts against the side of a respective one of the primary tubes 106. Where the tube positioning guides 206 comprise a crowned V-block, a ridge associated with each of the V-blocks contacts a respective one of the primary tubes 106.

Once the jig 200 is in place and the primary tubes 106 are held against the interior wall 119 of the outer tube 103, various welding operations may be performed to weld the ends of the primary tubes 106 to the interior wall 119 of the outer tube 103. The welding of the primary tubes 106 to the outer tube 103 may be accomplished by way of laser welding, flame welding, hydrogen welding, propane welding, arc welding, plasma welding, or other appropriate type of welding. After the welding is completed, the jig 200 may be extracted from the outer tube 103 as described above.

Referring next to FIG. 9C, shown is a flowchart of an example of a method 240 for assembling a hollow core optical fiber preform. To begin, in box 243 a step is performed of inserting a plurality of primary tubes 106 (FIG. 1) within an outer tube 103 (FIG. 1). Thereafter in box 246, a step is performed of inserting a jig 200 (FIG. 9A) having a center body 203 (FIG. 9A) and a plurality of tube positioning guides 206 (FIG. 9A) into the outer tube 103, each of the tube positioning guides 206 being connected to the center body 203 by way of a living hinge 209 (FIG. 9A). Next in box 249, a step is performed of positioning each of the primary tubes 106 against an interior wall 119 (FIG. 9B) of the outer tube 103 by way of the tube positioning guides 206, where a first set of the living hinges 209 extends longitudinally from the center body 203 in a first direction 219a (FIG. 9A), and a second set of the living hinges 209 extends longitudinally from the center body 203 in a second direction 219b (FIG. 9A), the second direction 219b being the opposite of the first direction 219a.

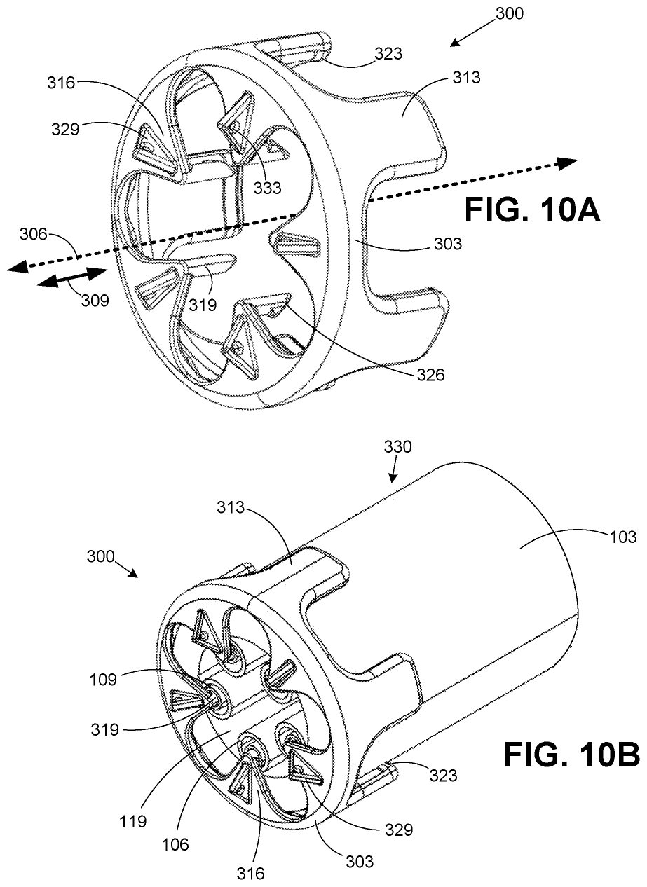

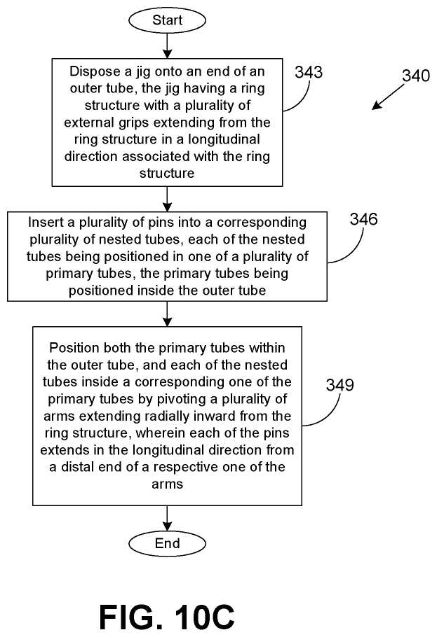

Referring next to FIG. 10A shown is an example of an external jig 300 that is employed in the assembly of hollow core optical fiber preforms 100. The external jig 300 includes a ring structure 303. The ring structure 303 includes a center longitudinal axis 306 that runs through a center of the ring structure 303, where the ring structure 303 is orthogonal to the center longitudinal axis 306. As contemplated herein, a “longitudinal direction” comprises a direction that is parallel to the center longitudinal axis 306 associated with the external jig 300.

The external jig 300 includes a plurality of external grips 313 that extend from the ring structure 303 in the longitudinal direction 309 associated with the ring structure 303. The external jig 300 also includes a plurality of arms 316 that extend radially inward from the ring structure 303 toward the center longitudinal axis 306. The external jig 300 includes a plurality of pins 319, where each of the pins 319 extends in a longitudinal direction 309 from a distal end of a respective one of the arms 316. In this respect, each of the pins 319 is positioned at a distal end of a respective one of the arms 316. Also, the longitudinal direction in which each of the pins 319 extends is the same as the longitudinal direction in which the external grips 313 extend.

Each of the external grips 313 includes a radially inward projection 323. Individual ones of the radially inward projections 323 extend from a distal end of a respective one of the external grips 313. The radially inward projections 323 advantageously grip a side of the outer tube 103 as will be discussed.

Each of the pins 319 includes a taper 326. In one example, the taper 326 of each of the pins is positioned on a radially outward facing side of the pins 319 relative to the center longitudinal axis 306, respectively. The taper 326 positioned on each one of the pins 319 advantageously facilitates the installation of the external jig 300 as will be discussed. Also, the external jig 300 includes a plurality of manually activated flex tabs 329. Each of the manually activated flex tabs 329 includes a hole 333 into which a tool may be inserted to pull back on a respective one of the arms 316 or on multiple ones of the arms 316. Alternatively, the manually activated flex tabs 329 maybe grasped by an individual and pulled back, as well, in order to install the external jig 300 onto an outer tube 103 (FIG. 1) while positioning the primary tubes 106 (FIG. 1) as will be described.

With reference to FIG. 10B, shown is the external jig 300 as it's installed onto the end of a hollow core optical fiber preform pre-assembly 330. The pre-assembly 330 includes the outer tube 103, the primary tubes 106, and the nested tubes 109. As shown, the primary tubes 106 are not yet affixed to the interior wall 119 of the outer tube 103. Also, the nested tubes 109 are not yet affixed inside the primary tubes 106.

To begin, the external jig 300 is pushed onto the end of the outer tube 103. In doing so, the radially inward projections 323 cause the distal ends of the external grips 313 to move in a radially outward direction where the proximal end of the external grips 313 pivots at the ring structure 303.

By pivoting each of the external grips 313, the ring structure 303 twists and causes the arms 316 to rotate such that the pins 319 move simultaneously in both the longitudinal direction inward toward the primary tubes 106 and the nested tubes 109, and in a radially outward direction. As the external jig 300 is placed over the end of the outer tube 103, the pins 319 are inserted into both the nested tubes 109 and the primary tubes 106. The taper 326 (FIG. 10A) on the pins 319 aids in the insertion of the pins 319 into the nested tubes 109.

As the arms 316 pivot with the twisting of the ring structure 303, the primary tubes 106 and the nested tubes 109 are simultaneously positioned within the outer tube 103, where the primary tubes 106 are pushed against the interior wall 119 of the outer tube 103 by the pin 319. In one example, the taper 326 of each of the pins 319 is positioned on a radially outward facing side of the pins 319 relative to the center longitudinal axis 306 (FIG. 10A). In order to aid in locating the pins 319, one may grasp the respective manually activated flex tabs 329 to pull individual ones of the arms 316, thereby counter rotating the respective arms 316 to facilitate a fit of the pins 319 into a respective one of the nested tubes 109 and primary tubes 106.

Once the primary tubes 106 and the nested tubes 109 are held in place within the outer tube 103, a welding operation may be performed to affix the primary tubes 106 to the outer tube 103, and the nested tubes 109 to the respective primary tubes 106. The various types of welding employed may include laser welding, flame welding, hydrogen welding, propane welding, arc welding, plasma welding, or other appropriate type of welding.

The external jig 300 may be constructed of various materials such as a flexible polymer, metal, or other material that provides for controlled compliance while maintaining sufficient rigidity to retain the primary tubes 106 and the nested tubes 109 in their relative positions for welding. The external jig 300 may be 3D printed using such materials. Also, the manually activated flex tabs 329 make it easier to move the pins 319 as the external jig 300 is placed over the end of the outer tube 103 to position the pins 319 into the primary tubes 106 and the nested tubes 109 as shown.

In addition, the external jig 300 compensates for small variations in diameter in the outer tube 103, primary tubes 106, and the nested tubes 109 without applying excessive force or causing unwanted deformation. The tapers 326 in the pins 319 facilitate relatively easy insertion of the pins 319 into the primary tubes 106 and the nested tubes 109 when the external jig 300 is installed and the flexible nature of the external jig 300 facilitates simple and efficient removal from a finished hollow core optical fiber preform 100. Also, by pressing the primary tubes 106 and the nested tubes 109 against the interior wall 119 of the outer tube 103, the external jig 300 ensures that they remain in fixed alignment, reducing movement that could cause misalignment or inconsistency in construction of the resulting hollow core optical fiber preform 100.

For a given jig 300, the number of pins 319 may vary depending on the number of primary tubes 106 and corresponding nested tubes 109 that are to be positioned within the outer tube 103. For example, although there are pins 319 to position five primary tubes 106 as shown, the number of pins 319 may be 3, 4, 5, 6, 7, 8, 9, or some other number. Alternatively, the number of pins 319 included in the jig 300 may position a number of primary tubes 106 that falls into a range of 3 to 9, 4 to 8, 5 to 7, or other range.

Referring next to FIG. 10C, shown is a flowchart of an example of a method 340 for assembling a hollow core optical fiber preform 100 (FIG. 1). The method begins at box 343 by disposing a jig 300 (FIG. 10B) onto an end of an outer tube 103 (FIG. 10B), the jig 300 having a ring structure 303 (FIG. 10B) with a plurality of external grips 313 (FIG. 10B) extending from the ring structure 303 in a longitudinal direction 309 (FIG. 10A) associated with the ring structure 303.

The method continues at box 346 by inserting a plurality of pins 319 (FIG. 10A) into a corresponding plurality of nested tubes 109 (FIG. 10B), each of the nested tubes 109 being positioned in one of a plurality of primary tubes 106 (FIG. 10B), the primary tubes 106 being positioned inside the outer tube 103.

At box 349, the method further includes positioning both the primary tubes 106 within the outer tube 103, and each of the nested tubes 109 inside a corresponding one of the primary tubes 106 by pivoting a plurality of arms 316 (FIG. 10B) extending radially inward from the ring structure 303, wherein each of the pins 319 extends in the longitudinal direction 309 from a distal end of a respective one of the arms 316.

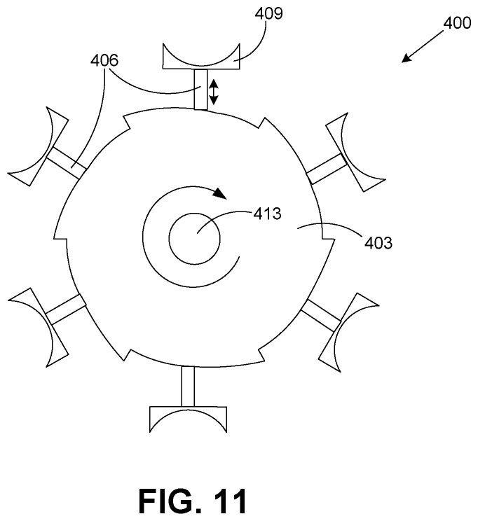

Turning next to FIG. 11, shown is a block diagram of an example of a cam-driven clamping jig 400 used to assemble a hollow core optical fiber preform 100 (FIG. 1). The cam-driven clamping jig 400 includes a rotating cam 403 that translates the rotational movement into linear movement of pins 406. The pins 406 push or pull against tube positioning guides 409. The rotating cam 403 includes a rachet mechanism 413 that maintains the position of the rotating cam 403 when rotational force is removed from the rotating cam 403. This allows the rotating cam 403 to be rotated in small increments to optimize the force applied to the tube positioning guides 409 to maintain the position of the tube positioning guides 409 without damaging the primary tubes 106 (FIG. 1) or the outer tube 103 (FIG. 1). The outer tube 103 may be held in a fixture or other structure so that it does not rotate with the application of rotational force to the rotating cam 403.

The rotating cam 403 is part of a structure that is inserted into an outer tube 103 between the primary tubes 106. Once inserted, the rotating cam 403 is turned the requisite amount to hold the primary tubes 106 against the interior wall 119 (FIG. 3) of the outer tube 103. The structure ensures the tube positioning guides 409 position the primary tubes 106 in even intervals around the interior wall 119 of the outer tube 103.

For a given jig 400, the number of tube positioning guides 409 may vary. For example, although there are tube positioning guides 409 to position six primary tubes 106, the number of tube positioning guides 409 may be 3, 4, 5, 6, 7, 8, 9, or some other number. Alternatively, the number of tube positioning guides 409 included in the jig 400 may position a number of primary tubes 106 that falls into a range of 3 to 9, 4 to 8, 5 to 7, or other range.

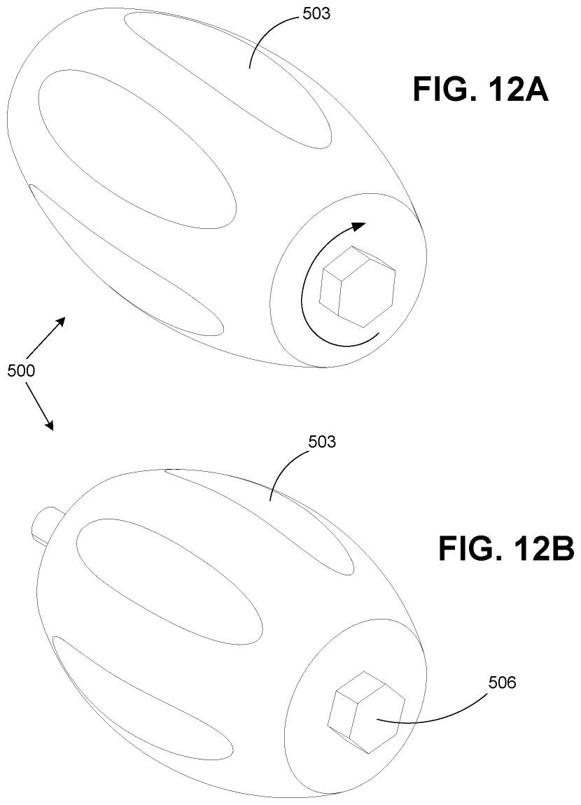

With reference to FIGS. 12A and 12B, shown is an example an expansion insert 500 used to assemble a hollow core optical fiber preform 100 (FIG. 1). The expansion insert 500 includes multiple tube positioning guides 503 and an expansion bolt 506. As the expansion bolt 506 is tightened, the central portion of the expansion insert 500 expands radially outward. As the expansion bolt 506 is loosened, the central portion of the expansion insert 500 retracts radially inward. The tube positioning guides 503 may be made of a more rigid material so that the expansion of the central portion of the expansion insert 500 does not deform the tube positioning guides 503.

During use, the expansion insert 500 is inserted into the outer tube 103 and the expansion bolt 506 is tightened. The outer tube 103 may be held in a fixture or other structure so that it does not rotate with the application of rotational force to the expansion bolt 506. As rotational force is applied to the expansion bolt 506, the tube positioning guides 503 move in a radially outward direction and apply a force against the primary tubes 106 to hold them against the interior wall 119.

For a given expansion insert 500, the number of tube positioning guides 503 may vary. For example, although there are tube positioning guides 503 to position six primary tubes 106 (with three visible in FIGS. 12A and 12B), the number of tube positioning guides 503 may be 3, 4, 5, 6, 7, 8, 9, or some other number. Alternatively, the number of tube positioning guides 503 included in the expansion insert 500 may position a number of primary tubes 106 that falls into a range of 3 to 9, 4 to 8, 5 to 7, or other range.

In addition to the foregoing, the various approaches of the present disclosure include, but are not limited to, the approaches set forth in the following clauses.

Clause 1 is an apparatus for assembly of an optical fiber preform, comprising a center insert having at least one primary tube positioning guide, the at least one primary tube positioning guide being configured to position a corresponding at least one primary tube against an interior wall of an outer tube; a projection that extends outward from the center insert, the projection including at least one nested tube guide, where the at least one nested tube guide is configured to hold a corresponding at least one nested tube against an inner wall of the at least one primary tube; and the projection holding the at least one nested tube simultaneously with the positioning of the at least one primary tube against the interior wall of the outer tube.

Clause 2 is the apparatus as set forth in clause 1, wherein the at least one primary tube positioning guide further comprises a plurality of primary tube positioning guides, the at least one primary tube further comprises a plurality of primary tubes, the at least one nested tube guide further comprises a plurality of nested tube guides, and the at least one nested tube further comprises a plurality of nested tubes.

Clause 3 is an apparatus as set forth in clause 2, wherein the primary tube positioning guides are angularly spaced in even intervals.

Clause 4 is an apparatus as set forth in any one of clauses 1-3, wherein the primary tube positioning guides are concave.

Clause 5 is an apparatus as set forth in any one of clauses 1-4, wherein the primary tube positioning guides are V-shaped, where individual ones of a pair of flat faces of a respective one of the primary tube positioning guides are configured to contact a respective one of the primary tubes.

Clause 6 is an apparatus as set forth in any one of clauses 1-5, wherein the primary tube positioning guides have a curvature that matches an outer diameter of the primary tubes.

Clause 7 is an apparatus as set forth in any one of clauses 1-6, wherein the projection is disk-shaped.

Clause 8 is an apparatus as set forth in any one of clauses 1-7, wherein the projection is disk-shaped and individual ones of the nested tube guides further comprise a cutout that seats a respective one of the nested tubes.

Clause 9 is an apparatus is an apparatus as set forth in clause 8, wherein the cutout is concave.

Clause 10 is an apparatus is an apparatus as set forth in clause 8, wherein the cutout is V-shaped.

Clause 11 is an apparatus as set forth in any one of clauses 1-10, wherein the primary tube positioning guides and the nested tube guides are radially aligned.

Clause 12 is an apparatus as set forth in any one of clauses 1-10, wherein the primary tube positioning guides and the nested tube guides are radially misaligned.

Clause 13 is an apparatus as set forth in any one of clauses 1-12, wherein the center insert includes a number of primary tube positioning guides selected from a group consisting of 3, 4, 5, 6, 7, 8, and 9.

Clause 14 is an apparatus as set forth in any one of clauses 1-12, wherein the center insert includes a number of primary tube positioning guides that falls within a range of 3 to 9.

Clause 15 is an apparatus as set forth in any one of clauses 1-12, wherein the center insert includes a number of primary tube positioning guides that falls within a range of 4 to 8.

Clause 16 is an apparatus as set forth in any one of clauses 1-12, wherein the center insert includes a number of primary tube positioning guides that falls within a range of 5 to 7.

Clause 17 is an arrangement for assembly of an optical fiber preform, comprising an outer tube; a plurality of primary tubes within the outer tube; a plurality of nested tubes, where individual ones of the nested tubes are positioned within corresponding ones of the primary tubes; and a jig that simultaneously positions individual ones of the primary tubes against an interior wall of the outer tube and individual ones of the nested tubes inside a corresponding one of the primary tubes.

Clause 18 is an arrangement as set forth in clause 17, wherein the jig further comprises a center insert having a plurality of primary tube positioning guides, where individual ones of the primary tube positioning guides position a respective one of the primary tubes against the interior wall.

Clause 19 is an arrangement as set forth in any one of clauses 17 or 18, wherein the center insert positions the primary tubes against the interior wall relative to each other.

Clause 20 is an arrangement as set forth in any one of clauses 17-19, wherein the primary tubes are positioned at a plurality of even intervals around the interior wall.

Clause 21 is an arrangement as set forth in any one of clauses 17-20, wherein the primary tube positioning guides are concave.

Clause 22 is an arrangement as set forth in any one of clauses 17-20, wherein the primary tube positioning guides are V-shaped, where individual ones of a pair of flat faces of a respective one of the primary tube positioning guides contacts a respective one of the primary tubes.

Clause 23 is an arrangement as set forth in any one of clauses 17-20, wherein the primary tube positioning guides have a curvature that matches an outer diameter of the primary tubes.

Clause 24 is an arrangement as set forth in any one of clauses 17-23, wherein the jig further comprises a projection that extends outward from the center insert, the projection including a plurality of nested tube guides, where individual ones of the nested tube guides hold a respective one of nested tubes against an inner wall of a respective one of the nested tubes.

Clause 25 is an arrangement as set forth in clause 24, wherein the projection is disk-shaped.

Clause 26 is an arrangement as set forth in clause 24, wherein the projection is disk-shaped and individual ones of the nested tube guides further comprise a cutout that seats a respective one of the nested tubes.

Clause 27 is an arrangement as set forth in any one of clauses 17-26, wherein the nested tubes extend longitudinally beyond an end of the primary tubes.

Clause 28 is an arrangement as set forth in clause 26, wherein the cutout is concave.

Clause 29 is an arrangement as set forth in clause 26, wherein the cutout is V-shaped.

Clause 30 is an arrangement as set forth in any one of clauses 17-29, wherein a number of primary tubes within the outer tube is selected from a group consisting of 3, 4, 5, 6, 7, 8, and 9.

Clause 31 is an arrangement as set forth in any one of clauses 17-29, wherein a number of primary tubes within the outer tube falls within a range of 3 to 9.

Clause 32 is an arrangement as set forth in any one of clauses 17-29, wherein a number of primary tubes within the outer tube falls within a range of 4 to 8.

Clause 33 is an arrangement as set forth in any one of clause 17-29, wherein a number of primary tubes within the outer tube falls within a range of 5 to 7.

Clause is an arrangement as set forth in any one of clauses 17-33, wherein a plurality of first points of contact between individual ones of the primary tubes and the interior wall of the outer tube and a plurality of second points of contact between individual ones of the nested tubes and corresponding ones of the primary tubes are radially aligned.

Clause 35 is an arrangement as set forth in any one of clauses 17-33, wherein a plurality of first points of contact between individual ones of the primary tubes and the interior wall of the outer tube and a plurality of second points of contact between individual ones of the nested tubes and corresponding ones of the primary tubes are radially misaligned.

Clause 36 is a method, comprising positioning at least one primary tube within an outer tube; positioning at least one nested tube within the corresponding at least one primary tube; employing a jig to simultaneously position the at least one primary tube against an interior wall of the outer tube, and the at least one nested tube against an inner wall of the at least one primary tube.

Clause 37 is a method as set forth in clause 36, wherein the at least one primary tube further comprises a plurality of primary tubes, and the at least one nested tube further comprises a plurality of nested tubes.

Clause 38 is a method as set forth in clause 37, wherein the positioning of the individual ones of the primary tubes further comprises positioning primary tubes against the interior wall of the outer tube with a center insert having a plurality of primary tube positioning guides.

Clause 39 is a method as set forth in any one of clauses 36-38, further comprising positioning the primary tubes against the interior wall relative to each other.

Clause 40 is a method as set forth in any one of clauses 36-39, further comprising positioning the primary tubes at a plurality of even intervals around the interior wall.

Clause 41 is a method as set forth in any one of clauses 36-40, wherein the primary tube positioning guides have a curvature that matches an outer diameter of the primary tubes.

Clause 42 is a method as set forth in any one of clauses 36-41, further comprising positioning the nested tubes against the inner wall of the corresponding one of the primary tubes by way of a projection that extends outward from the center insert, the projection including a plurality of nested tube guides that hold the individual ones of the nested tubes.

Clause 43 is a method as set forth in clause 42, wherein the projection is disk-shaped.

Clause 44 is a method as set forth in clause 42, wherein the projection is disk-shaped and individual ones of the nested tube guides further comprise a cutout that seats a respective one of the nested tubes.

Clause 45 is a method as set forth in any one of clauses 36-44, further comprising extending the nested tubes longitudinally beyond an end of the primary tubes.

Clause 46 is a method as set forth in any one of clauses 36-45, wherein a number of primary tubes within the outer tube is selected from a group consisting of 3, 4, 5, 6, 7, 8, and 9.

Clause 47 is a method as set forth in any one of clauses 36-45, wherein a number of primary tubes within the outer tube falls within a range of 3 to 9.

Clause 48 is a method as set forth in any one of clauses 36-45, wherein a number of primary tubes within the outer tube falls within a range of 4 to 8.

Clause 49 is a method as set forth in any one of clauses 36-45, wherein a number of primary tubes within the outer tube falls within a range of 5 to 7.

Clause 50 is a method as set forth in any one of clauses 36-49, further comprising radially aligning a plurality of first points of contact between individual ones of the primary tubes and the interior wall of the outer tube, and a corresponding plurality of second points of contact between individual ones of the nested tubes and corresponding ones of the primary tubes.

Clause 51 is a method as set forth in any one of clauses 36-49, further comprising radially misaligning a plurality of first points of contact between individual ones of the primary tubes and the interior wall of the outer tube, and a plurality of second points of contact between individual ones of the nested tubes and corresponding ones of the primary tubes.

Clause 52 is an apparatus for assembly of an optical fiber preform, comprising a center body; a plurality of tube positioning guides; a plurality of living hinges, each of the living hinges connecting a respective one of the tube positioning guides to the center body; a first set of the living hinges extending longitudinally from the center body in a first direction; and a second set of the living hinges extending longitudinally from the center body in a second direction, the second direction being opposite the first direction.

Clause 53 is an apparatus as set forth in clause 52, wherein each of the living hinges flexes to move a respective one of the tube positioning guides in a direction perpendicular to a center longitudinal axis of the apparatus.

Clause 54 is an apparatus as set forth in any one of clauses 52 or 53, wherein each of the tube positioning guides extends radially outward relative to a position of a corresponding one of the living hinges.

Clause 55 is an apparatus as set forth in any one of clauses 52-54, wherein each of the tube positioning guides further comprises a V-block.

Clause 56 is an apparatus as set forth in any one of clauses 52-54, wherein each of the tube positioning guides further comprises a crowned V-block.

Clause 57 is an apparatus as set forth in any one of clauses 52-56, further comprising an extraction hole in the center body.

Clause 58 is an apparatus as set forth in any one of clauses 52-57, wherein the tube positioning guides are arranged in a plurality of longitudinally aligned pairs, each of the longitudinally aligned pairs including first one of the tube positioning guides attached to a first one of the living hinges from the first set and a second one of the tube positioning guides attached to a second one of the living hinges from the second set.

Clause 59 is an apparatus as set forth in clause 58, wherein the longitudinally aligned pairs are arranged in a polygonal configuration.

Clause 60 is an apparatus as set forth in any one of clauses 52-59, further comprising a gap between adjacent ones of the tube positioning guides, wherein a width of the gap prevents an interference between the adjacent ones of the tube position guides during an operational flexing of corresponding ones of the living hinges.

Clause 61 is an apparatus as set forth in any one of clauses 52-59, further comprising a gap between adjacent ones of the tube positioning guides, wherein a width of the gap prevents an over-flexing of respective adjacent ones of the living hinges.

Clause 62 is an apparatus as set forth in any one of clauses 52-61, wherein a plurality of ends of the tube positioning guides are tapered in a longitudinal direction.

Clause 63 is a method for assembly of an optical fiber preform, comprising inserting a plurality of primary tubes within an outer tube; inserting a jig having a center body and a plurality of tube positioning guides into the outer tube, each of the tube positioning guides being connected to the center body by way of a living hinge; and positioning each of the primary tubes against an interior wall of the outer tube by way of the tube positioning guides, where a first set of the living hinges extends longitudinally from the center body in a first direction, and a second set of the living hinges extends longitudinally from the center body in a second direction, the second direction being the opposite of the first direction.

Clause 64 is a method as set forth in clause 63, wherein the primary tubes are positioned at even intervals around the interior wall of the outer tube.

Clause 65 is a method as set forth in any one of clauses 63 or 64, further comprising flexing the living hinges radially inward when the tube positioning guides contact the primary tubes to accommodate a diameter of each of the primary tubes.

Clause 66 is a method as set forth in any one of clauses 63-65, wherein each of the tube positioning guides further comprises a V-block, the method further comprising contacting each side of a respective one of the V-blocks against a respective one of the primary tubes.

Clause 67 is a method as set forth in any one of clauses 63-66, wherein each of the tube positioning guides further comprises a crowned V-block, the method further comprising contacting a ridge associated with each of the crowned V-blocks against a respective one of the primary tubes.

Clause 68 is a method as set forth in any one of clauses 63-67, further comprising placing a hook in an extraction hole in the center body; and extracting the jig from the outer tube.

Clause 69 is a method as set forth in any one of clauses 63-68, further comprising positioning the tube positioning guides into a plurality of longitudinally aligned pairs, each of the longitudinally aligned pairs including a first one of the tube positioning guides attached to a first one of the living hinges from the first set and a second one of the tube positioning guides attached to a second one of the living hinges from the second set.

Clause 70 is a method as set forth in clause 69, further comprising arranging the longitudinally aligned pairs in a polygonal configuration.

Clause 71 is a method as set forth in any one of clauses 63-70, further comprising preventing an interference between adjacent ones of the tube positioning guides during an operational flexing of the living hinges by way of a gap between the adjacent ones of the tube positioning guides.

Clause 72 is an apparatus for assembly of an optical fiber preform, comprising a ring structure; a plurality of external grips extending from the ring structure in a longitudinal direction associated with the ring structure; a plurality of arms extending radially inward from the ring structure; a plurality of pins, each pin extending in the longitudinal direction from a respective one of the arms.

Clause 73 is an apparatus as set forth in clause 72, wherein each of the pins are positioned at a distal end of a respective one of the arms.

Clause 74 is an apparatus as set forth in any one of clauses 72 or 73, wherein each of the pins is tapered.

Clause 75 is an apparatus as set forth in any one of clauses 72-74, wherein each of the pins is tapered on a radially outward facing side.

Clause 76 is an apparatus as set forth in any one of clauses 72-75, further comprising a plurality of radially inward projections, each of the radially inward projections extending from a distal end of a respective one of the external grips.

Clause 77 is an apparatus as set forth in any one of clauses 72-76, wherein a distal end of each of the external grips pivot in a radially outward direction, thereby causing the ring structure to twist and causing the arms to rotate such that the pins move simultaneously in both the longitudinal direction and a radially outward direction.

Clause 78 is a method for assembly of an optical fiber preform, comprising disposing a jig onto an end of an outer tube, the jig having a ring structure with a plurality of external grips extending from the ring structure in a longitudinal direction associated with the ring structure; inserting a plurality of pins into a corresponding plurality of nested tubes, each of the nested tubes being positioned in one of a plurality of primary tubes, the primary tubes being positioned inside the outer tube; and positioning both the primary tubes within the outer tube and each of the nested tubes inside a corresponding one of the primary tubes by pivoting a plurality of arms extending radially inward from the ring structure, wherein each of the pins extends in the longitudinal direction from a distal end of a respective one of the arms.

Clause 79 is a method as set forth in clauses 78, further comprising positioning each of the pins at a distal end of a respective one of the arms.

Clause 80 is a method as set forth in any one of clauses 78 or 79, wherein the disposing of the jig onto the end of the outer tube further comprises sliding the external grips over the end of the outer tube.

Clause 81 is a method as set forth in any one of clauses 78-80, wherein a plurality of radially inward projections extend from a distal end of corresponding ones of the external grips, the method further comprising contacting the radially inward projections against an outer surface of the outer tube causing the distal end of each one of the external grips to pivot away from an outer surface.

Clause 82 is a method as set forth in any one of clauses 78-81, further comprising tapering each of the pins on a radially outward facing side.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

It should be emphasized that the above-described examples of the present disclosure are merely possible examples of implementations set forth for a clear understanding of the principles of the disclosure. Many variations and modifications may be made to the above-described example(s) without departing substantially from the spirit and principles of the disclosure. All such modifications and variations are intended to be included herein within the scope of this disclosure and protected by the following claims.

Therefore, the following is claimed:

1. An apparatus for assembly of an optical fiber preform, comprising:
a center insert having at least one primary tube positioning guide, the at least one primary tube positioning guide being configured to position a corresponding at least one primary tube against an interior wall of an outer tube;
a projection that extends outward from the center insert, the projection including at least one nested tube guide, where the at least one nested tube guide is configured to hold a corresponding at least one nested tube against an inner wall of the at least one primary tube; and
the projection holding the at least one nested tube simultaneously with the positioning of the at least one primary tube against the interior wall of the outer tube.

2. The apparatus of claim 1, wherein:
the at least one primary tube positioning guide further comprises a plurality of primary tube positioning guides;
the at least one primary tube further comprises a plurality of primary tubes;
the at least one nested tube guide further comprises a plurality of nested tube guides; and
the at least one nested tube further comprises a plurality of nested tubes.

3. The apparatus of claim 2, wherein the primary tube positioning guides are concave.

4. The apparatus of claim 2, wherein the primary tube positioning guides are V-shaped, where individual ones of a pair of flat faces of a respective one of the primary tube positioning guides are configured to contact a respective one of the primary tubes.

5. The apparatus of claim 2, wherein the projection is disk-shaped and individual ones of the nested tube guides further comprise a cutout that seats a respective one of the nested tubes.

6. The apparatus of claim 2, wherein the primary tube positioning guides and the nested tube guides are radially aligned.

7. An arrangement for assembly of an optical fiber preform, comprising:
an outer tube;
a plurality of primary tubes within the outer tube;
a plurality of nested tubes, where individual ones of the nested tubes are positioned within corresponding ones of the primary tubes; and
a jig that simultaneously positions individual ones of the primary tubes against an interior wall of the outer tube and individual ones of the nested tubes inside a corresponding one of the primary tubes.

8. The arrangement of claim 7, wherein the jig further comprises a center insert having a plurality of primary tube positioning guides, where individual ones of the primary tube positioning guides position a respective one of the primary tubes against the interior wall.

9. The arrangement of claim 8, wherein the center insert positions the primary tubes against the interior wall relative to each other.

10. The arrangement of claim 8, wherein the primary tube positioning guides are concave.

11. The arrangement of claim 8, wherein the primary tube positioning guides are V-shaped, where individual ones of a pair of flat faces of a respective one of the primary tube positioning guides contacts a respective one of the primary tubes.

12. The arrangement of claim 8, wherein the jig further comprises a projection that extends outward from the center insert, the projection including a plurality of nested tube guides, where individual ones of the nested tube guides hold a respective one of nested tubes against an inner wall of a respective one of the nested tubes.

13. The arrangement of claim 12, wherein the projection is disk-shaped and individual ones of the nested tube guides further comprise a cutout that seats a respective one of the nested tubes.

14. The arrangement of claim 7, wherein a plurality of first points of contact between individual ones of the primary tubes and the interior wall of the outer tube and a plurality of second points of contact between individual ones of the nested tubes and corresponding ones of the primary tubes are radially aligned.

15. An apparatus for assembly of an optical fiber preform, comprising:
a center body;
a plurality of tube positioning guides;
a plurality of living hinges, each of the living hinges connecting a respective one of the tube positioning guides to the center body;
a first set of the living hinges extending longitudinally from the center body in a first direction; and
a second set of the living hinges extending longitudinally from the center body in a second direction, the second direction being opposite the first direction.

16. The apparatus of claim 15, wherein each of the living hinges flexes to move a respective one of the tube positioning guides in a direction perpendicular to a center longitudinal axis of the apparatus.

17. The apparatus of claim 15, wherein each of the tube positioning guides extends radially outward relative to a position of a corresponding one of the living hinges.

18. The apparatus of claim 15, further comprising an extraction hole in the center body.

19. The apparatus of claim 15, wherein the tube positioning guides are arranged in a plurality of longitudinally aligned pairs, each of the longitudinally aligned pairs including first one of the tube positioning guides attached to a first one of the living hinges from the first set and a second one of the tube positioning guides attached to a second one of the living hinges from the second set.

20. The apparatus of claim 15, wherein a plurality of ends of the tube positioning guides are tapered in a longitudinal direction.
